(19) United States
(12) Patent Application Publication
(10) Pub. No.: US 2010/0208471 A1
(43) Pub. Date: Aug. 19, 2010

(54) Liner for recessed light housing

(76) Inventor: Timothy L. Sell, Plymouth, MI (US)

Correspondence Address: ANDREW W. LUDY, 17 SHERWOOD WAY, P.O. Box 418, Mt. Arlington, NJ, 07856, US

(21) Appl. No.: 12/378,503

(22) Filed: Feb. 17, 2009

(51) Int. Cl. F21V 15/00

(52) U.S. Cl. 362/365

(57) ABSTRACT

A liner, to minimize heat loss from a building, is used in connection with a recessed light housing having a can and mounted in a panel. The liner has a molded plastic shell. An electrical light socket is mounted in the shell and is connected to a source of electrical current. A pair of nylon cable tie grommets, each with an integrated ratchet, is mounted in the shell roof. A pair of nylon cable tie tapes, each having an integrated gear rack, is passed through the grommets, pulled tight, and cut off. Each gear rack is able to mesh with one of the ratchets, to allow each tape to pass through the respective grommet in one direction only. A threaded fastener secures the tape to the can. An elastomer seal limits air leakage. An optional ocular plate, such as a diffuser, a filter, or a fresnel lens, processes the light as desired.

### CROSS-REFERENCE TO RELATED APPLICATIONS

Not Applicable

### STATEMENT REGARDING FEDERALLY SPONSORED RESEARCH OR DEVELOPMENT

Not Applicable

### BACKGROUND OF THE INVENTION

This invention relates to the field of recessed light housings, and more particularly to an insulated liner or shell inserted into a recessed light housing.

It has become commonplace to install recessed lighting in ceilings, where the fixture is out of the way. Recessed lights provide comfortable light where it is needed, without harsh lateral lighting. These fixtures pose several problems. Firstly, the fixture is sheet steel, with no insulation. Secondly, the fixture has holes and slots punched through it, allowing air to pass through. Estimates of heat losses in winter run up to $5.00 per fixture per year due to air leakage through the fixture. In summer, cool air is lost. Thirdly, moist air escaping through the fixtures into a freezing attic will condense, causing mold, mildew, and rot. Homeowners try to solve the problem with improvised box enclosures around the fixtures in the attic. In a cathedral ceiling, this may be impossible. Fourthly, unsealed fixtures provide an avenue for insects to enter the living spaces.

Accordingly, there is a need to provide a liner for a recessed light housing that is insulated to minimize heat loss.

There is a further need to provide a liner for a recessed light housing of the type described and that has no holes or slots punched through it, and so will eliminate the air draft heat loss through the fixture.

There is a yet further need to provide a liner for a recessed light housing of the type described and that will not allow moist air to escape through the fixture into a freezing attic and condense.

There is a still further need to provide a liner for a recessed light housing of the type described and that will prevent insects from entering the living spaces.

There is another need to provide a liner for a recessed light housing of the type described and that can be quickly and easily installed by a homeowner.

There is yet another need to provide a liner for a recessed light housing of the type described and that can be manufactured cost-effectively in large quantities of high quality.

### BRIEF SUMMARY OF THE INVENTION

In accordance with the present invention, there is provided a liner 36, for use in connection with a recessed light housing 22, mounted in a panel 24. The recessed light housing has a can 26 with apertures 28 therethrough and a source of electrical current 30 wired through a junction box 32. The liner 36 comprises a shell 38 with a sidewall 40, a roof 46, and a flange 48. The shell 38 is made of molded plastic, such as structural foam.

A first electrical light socket 50 is mounted in the shell 38, and is connected to the source of electrical current 30. The original, second electrical light socket is removed, and the wires are cut, stripped, and connected to the first electrical light socket 50 with wire nuts 52.

A pair of cable tie grommets 54, are mounted in the shell roof 46, and spaced apart from one another. Each grommet 54 has an integrated ratchet 56. A pair of cable tie tapes 58, each having an integrated gear rack 64, is inserted into the grommets 54, passed through, and pulled tight with pliers. Excess tape 58 is cut off. Each gear rack 64 is able to mesh with one of the ratchets 56, so as to allow each tape 58 to pass through the respective grommet 54 in one direction, but not in the opposite direction. Each tape 58 has a mounting pad 66 with a hole 68. A threaded fastener 70 through the hole 68 secures the tape 58 onto the can 26. Alternatively, a blind rivet or an adhesive can be used. The tapes and grommets are molded from nylon.

An elastomer seal 72, between the flange 48 and the can opening 34, limits air leakage past the liner 36, to minimize heat loss from the building. An optional ocular plate 74, such as a diffuser, a filter, or a fresnel lens, is mounted on the shell 38 to pass and process the light as desired.

### BRIEF DESCRIPTION OF THE SEVERAL VIEWS OF THE DRAWING

A more complete understanding of the present invention may be obtained from consideration of the following description in conjunction with the drawing, in which:

FIG. 1 is an exploded, perspective view of a liner for a recessed light housing constructed in accordance with the invention, showing installation of the liner in a recessed light housing.

FIG. 2 is a top plan view of the recessed light housing of FIG. 1.

FIG. 3 is a front sectional elevational view of the liner for a recessed light housing of FIG. 1, taken along lines 3-3 of FIG. 2.

FIG. 4 is an exploded, perspective view of another liner for a recessed light housing constructed in accordance with the invention, showing installation of the liner in a recessed light housing.

FIG. 5 is a top plan view of the recessed light housing of FIG. 4.

FIG. 6 is a front sectional elevational view of the liner for a recessed light housing of FIG. 4, taken along lines 6-6 of FIG. 5.

FIG. 7 is a front elevational view of a cable tie grommet with an integrated ratchet used with the liner for a recessed light housing of FIGS. 1 and 4.

FIG. 8 is a top plan view of the cable tie grommet of FIG. 7.

FIG. 9 is a front sectional elevational view of the cable tie grommet of FIG. 7, taken along lines 9-9 of FIG. 8.

FIG. 10 is a front elevational view of a cable tie polymer tape with an integrated gear rack, used with the liner for a recessed light housing of FIGS. 1 and 4.

FIG. 11 is an enlarged, sectional elevational view of the cable tie polymer tape of FIG. 10, taken along lines 11-11 of FIG. 10.

FIG. 12 is a right side elevational view of the cable tie polymer tape of FIG. 10.

FIG. 13 is a partial, sectional view of the cable tie polymer tape of FIG. 10, taken along lines 13-13 of FIG. 12.

FIG. 14 is an exploded, perspective view of yet another liner for a recessed light housing constructed in accordance with the invention; showing installation of the liner in a recessed light housing.

FIG. 15 is a top plan view of the recessed light housing of FIG. 14.

FIG. 16 is a front sectional elevational view of the liner for a recessed light housing of FIG. 14, taken along lines 16-16 of FIG. 15.

FIG. 17 is a perspective view of an electrical light socket wired to an electrical light plug, used with the liner for a recessed light housing of FIG. 14.

FIG. 18 is a front elevational view of a bolt used with the liner for a recessed light housing of FIG. 14.

FIG. 19 is a top view of a nut used with the liner for a recessed light housing of FIG. 14.

FIG. 20 is a front sectional elevational view of the nut of FIG. 19, taken along lines 20-20 of FIG. 19.

### DETAILED DESCRIPTION OF THE INVENTION

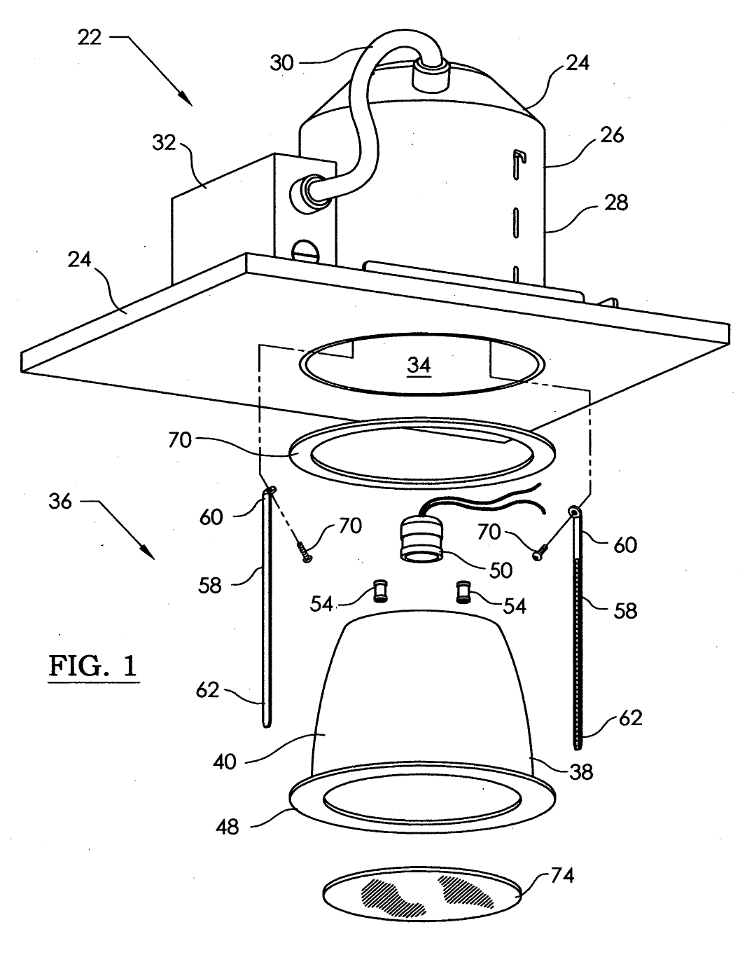

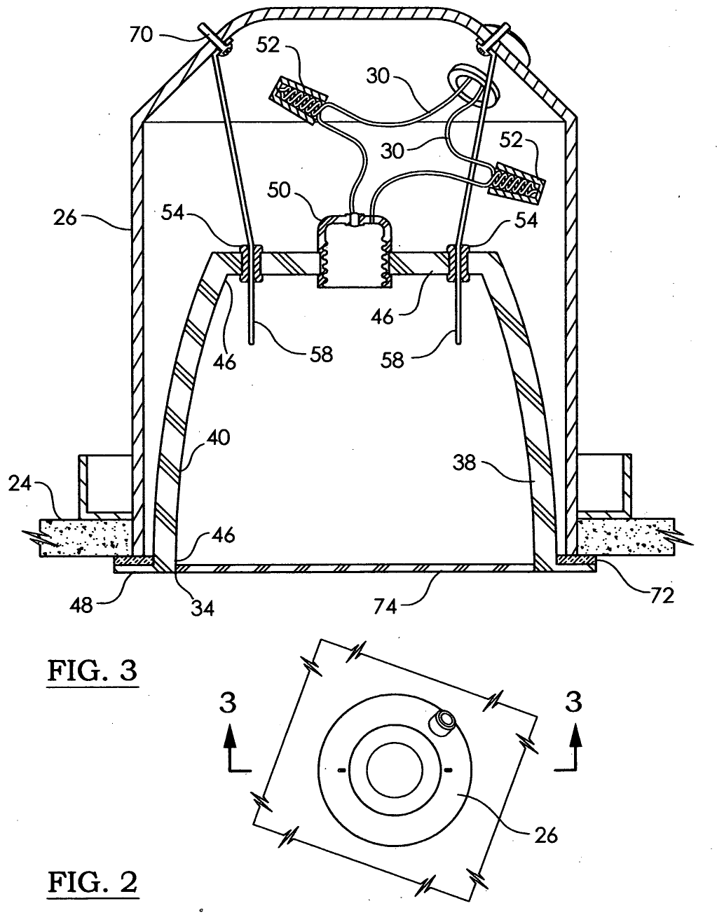

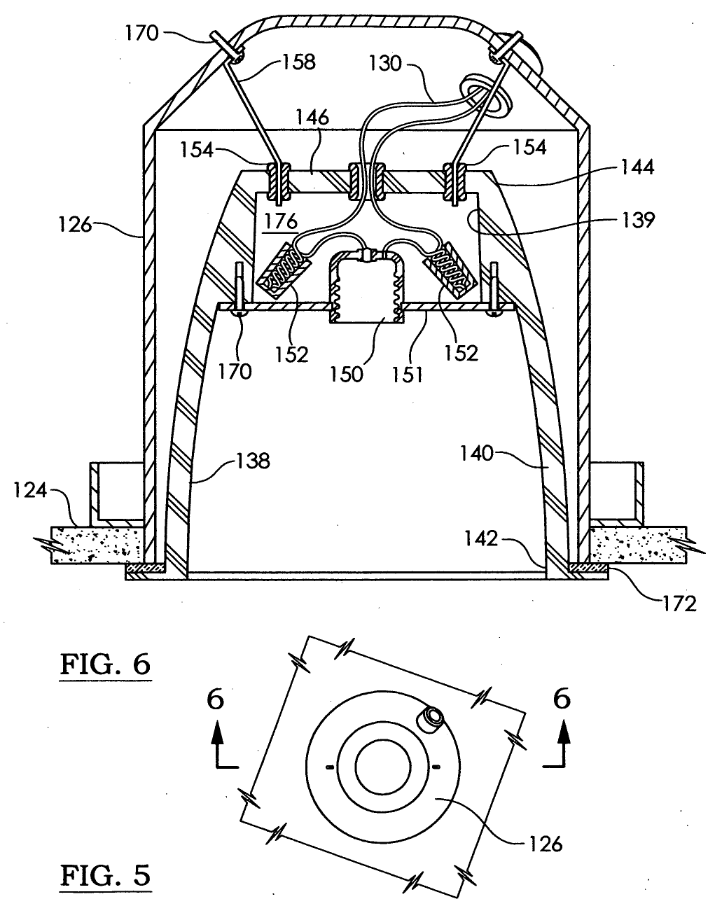

Referring now to the drawing, and especially to FIGS. 1-13 thereof, a liner is shown at 36, and is retrofitted to an existing recessed light housing 22, mounted in a panel 24. The panel 24 is typically drywall installed in a ceiling, but can be any wallboard or paneling. The recessed light housing has a can 26 with apertures 28 therethrough and a source of electrical current 30 wired through a junction box 32. The can 26 has an opening 34 adjacent the panel 24. The liner 36 comprises a shell 38 having a generally circular sidewall 40 extending from a lower end 42 adjacent the can opening 34 to an upper end 44. The shell 38 has a roof 46 at the upper end 44. The shell 38 has a flange 48 at the lower end 42. The flange 48 is adapted to overlap the can opening 34, as well as the opening cut into the panel 24, as shown in FIG. 3. The shell 38 is adapted to fit into the can 26 with some clearance all around. The shell 38 is preferably made of molded plastic, especially structural foam, which imparts strength and thermal insulation.

A first electrical light socket 50 is mounted in the shell roof 46. The first electrical light socket 50 is connected to the source of electrical current 30. The recessed light housing 22 comes equipped with a second (original) electrical light socket mounted on a bracket with a wing nut and bolt (not shown). Before installation of the liner 36, the second electrical light socket, the bracket, and the wing nut and bolt must be removed. The wires to the second electrical light socket are cut, stripped, and connected to the first electrical light socket 50 with wire nuts 52, as shown in FIG. 3.

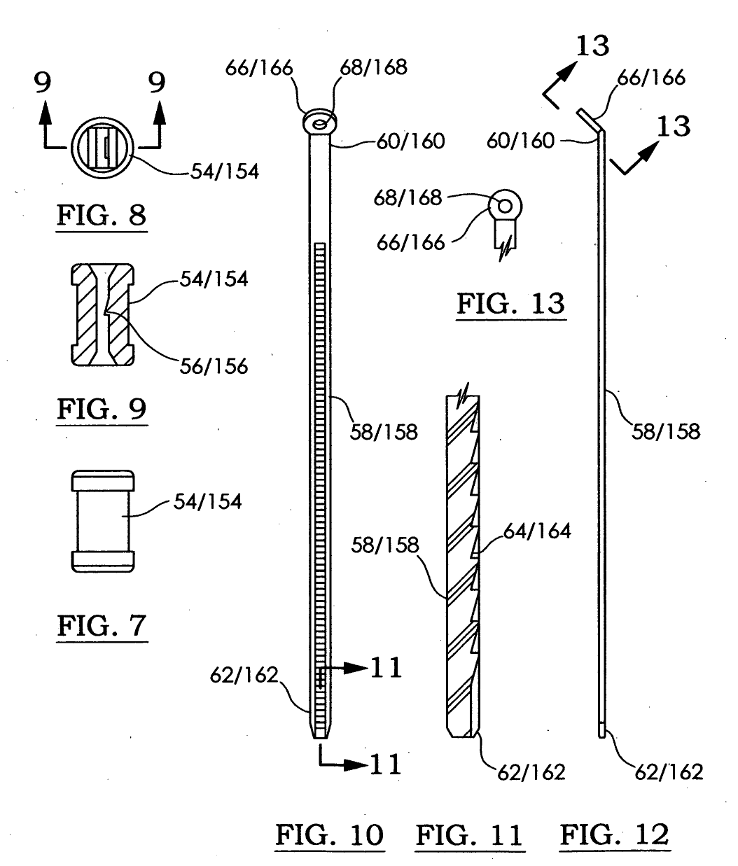

A pair of cable tie grommets 54, are mounted in the shell roof 46, and spaced apart from one another. Each grommet 54, shown in FIGS. 7, 8, and 9, has an integrated ratchet 56.

A pair of cable tie tapes 58, extend between opposite first 60 and second 62 ends. Each tape has an integrated gear rack 64. Each tape 58 is inserted into one of the grommets 54, passed through, and pulled tight with pliers. Excess tape 58 is cut off. Each gear rack 64 is able to mesh with one of the ratchets 56, so as to allow each tape 58 to pass through the respective grommet 54 in one direction, but not in the opposite direction. Each tape 58 has a mounting pad 66 on the first end 60 with a hole 68 through the pad 66. A threaded self-tapping fastener 70 is inserted through the hole 68 into a predrilled hole in the can, for securing the tape 58 onto the can 26. Alternatively, a blind rivet or an adhesive (not shown) can be used. The tapes and grommets are molded from a polymeric material, preferably nylon.

A seal 72 is interposed between the flange 48 and the can opening 34, so as to limit air leakage past the liner 36, and thereby minimize heat loss from the building. The seal 72 is made from an elastomer material so as to conform closely to the flange 48, the can opening 34, and the panel 24. The seal 72 is adapted to minimize airflow through the interface between the shell 38 and the can 26, and between the can 26 and the panel 24.

An optional ocular plate 74 is mounted on the shell 38 adjacent the lower end 42, so as to condition light and pass light outward. The ocular plate 74 can be a diffuser, a filter, a fresnel lens, or any element that will pass light outward, and process the light as desired. Mounting can be effected by snapping the ocular plate 74 into the shell 38 by means well known in the art.

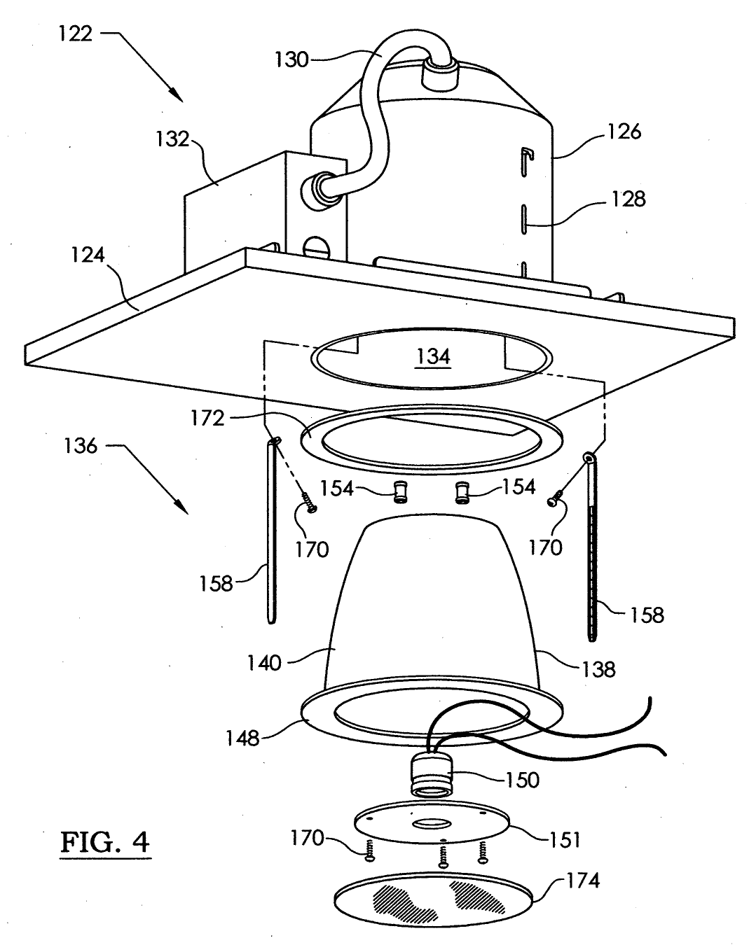

Turning now to FIGS. 4, 5, and 6, as well as FIGS. 7-13 thereof, a liner is shown at 136, and is for use in connection with a recessed light housing 122, mounted in a panel 124. The liner 136 is similar to liner 36 above in that the recessed light housing 122 has a can 126 with apertures 128 therethrough and a source of electrical current 130 wired through a junction box 132. The can 126 has an opening 134 adjacent the panel 124. The liner 136 comprises a shell 138 having a generally circular sidewall 140 extending from a lower end 142 adjacent the can opening 134 to an upper end 144. The shell 138 has a roof 146 at the upper end 144. The shell 138 has a flange 148 at the lower end 142. The flange 148 is adapted to overlap the can opening 134, as well as the opening cut into the panel 124. The shell 138 is adapted to fit into the can 126 with some clearance all around. The shell 138 has at least one, and preferably three, mounting bosses 139 spaced below the roof 146. The shell 138 is preferably made of molded plastic, especially structural foam, which imparts strength and thermal insulation.

The liner 136 differs from liner 36 above in that liner 136 has the mounting bosses 139, and a mounting plate 151 is attached to the mounting bosses 139 with threaded self-tapping fasteners 170. A first electrical light socket 150 is mounted in the mounting plate 151. A connection chamber 176 is enclosed by the mounting plate 151, the roof 146, and the sidewall 140, and is for making the connection between the first electrical light socket 150 and the source of electrical current 130.

The recessed light housing 122 comes equipped with a second (original) electrical light socket mounted on a bracket with a wing nut and bolt (not shown). Before installation of the liner 136, the second electrical light socket, the bracket, and the wing nut and bolt must be removed. The wires to the second electrical light socket are cut, stripped, and connected to the first electrical light socket 150 with wire nuts 152, as shown in FIG. 6.

A pair of cable tie grommets 154, are mounted in the shell roof 146, and spaced apart from one another. Each grommet 154, shown in FIGS. 7, 8, and 9, has an integrated ratchet 156.

A pair of cable tie tapes 158, extend between opposite first 160 and second 162 ends. Each tape has an integrated gear rack 164. Each tape 158 is inserted into one of the grommets 154, passed through, and pulled tight with pliers. Excess tape 158 is cut off. Each gear rack 164 is able to mesh with one of the ratchets 156, so as to allow each tape 158 to pass through the respective grommet 154 in one direction, but not in the opposite direction. Each tape 158 has a mounting pad 166 on the first end 160 with a hole 168 through the pad 166. A threaded self-tapping fastener 170 is inserted through the hole 168 into a predrilled hole in the can, for securing the mounting pad 166 onto the can 126. The tapes and grommets are molded from a polymeric material, preferably nylon.

A seal 172 is interposed between the flange 148 and the can opening 134, so as to limit air leakage past the liner 136, and thereby minimize heat loss from the building. The seal 172 is made from an elastomer material so as to conform closely to the flange 148, the can opening 134, and the panel 124. The seal 172 is adapted to minimize airflow through the interface between the shell 138 and the can 126, and between the can 126 and the panel 124.

An optional ocular plate 174 is mounted on the shell 138 adjacent the lower end 142, so as to condition light and pass light outward. The ocular plate 174 can be a diffuser, a filter, a fresnel lens, or any element that will pass light outward, and process the light as desired. Mounting can be effected by snapping the ocular plate 174 into the shell 138 by means well known in the art.

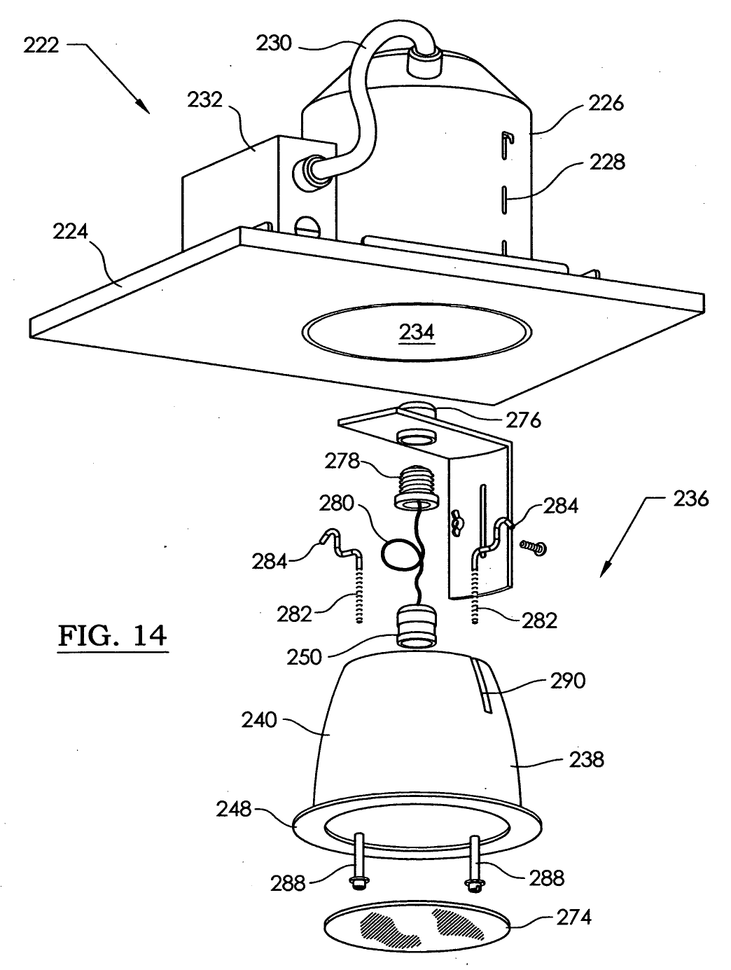

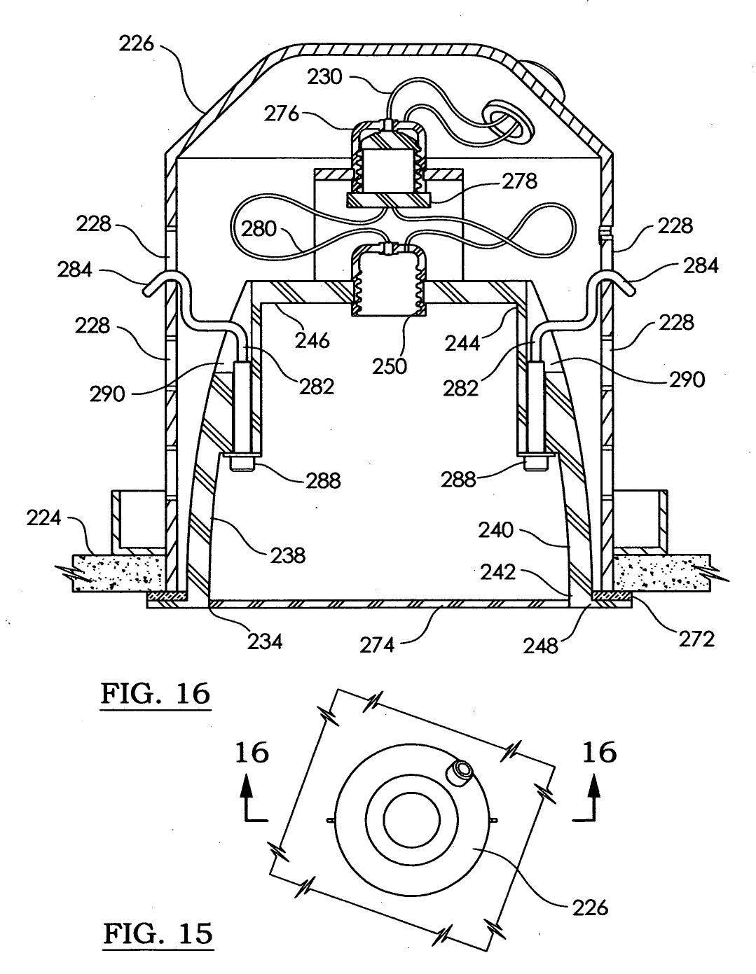

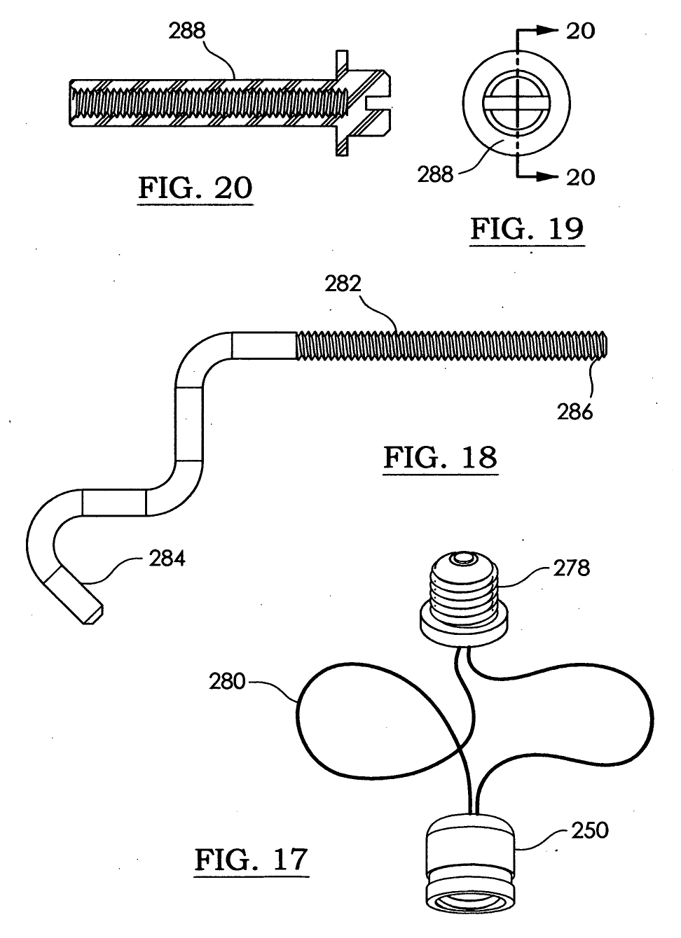

Referring now to FIGS. 14-20, another embodiment of the liner is shown at 236, and is for use in connection with a recessed light housing 222, mounted in a panel 224. The liner 236 is similar to liner 36 above in that the recessed light housing has a can 226 with apertures 228 therethrough and a source of electrical current 230 wired through a junction box 232. The can 226 has an opening 234 adjacent the panel 224. The liner 236 comprises a shell 238 having a generally circular sidewall 240 extending from a lower end 242 adjacent the can opening 234 to an upper end 244. The shell 238 has a roof 246 at the upper end 244. The shell 238 has at least one mounting hole 290 through the shell The shell 238 has a flange 248 at the lower end 242. The flange 248 is adapted to overlap the can opening 234, as well as the opening cut into the panel 224, as shown in FIG. 16. The shell 238 is adapted to fit into the can 226 with some clearance all around. The shell 238 is preferably made of molded plastic, especially structural foam, which imparts strength and thermal insulation.

A first electrical light socket 250 is mounted in the shell roof 246. The recessed light housing 222 comes equipped with a second (original) electrical light socket 276 mounted inside the can 226 on a bracket with a wing nut and bolt. The source of electrical current 230 is connected to the second electrical light socket 276, as originally equipped. A plug 278 is provided to screw into the second electrical light socket 276, making an electrical connection with the second electrical light socket 276. An electrical cord 280 electrically connects the plug 278 with the first electrical light socket 250.

Means is provided for mounting the shell 238 in the can 226. Specifically, at least one, and typically two, fasteners or bolts 282 attach the shell 238 to the can 226. Each bolt 282 extends between opposite upper 284 and lower 286 ends. The upper end 284 is hook-shaped, and is adapted to engage one of the apertures 228. The lower end 286 is threaded and adapted to pass through the mounting hole 290. At least one nut 288 is adapted to engage the threaded lower end 286 of the bolt 282.

A seal 272 is interposed between the flange 248 and the can opening 234, so as to limit air leakage past the liner 236, and thereby minimize heat loss from the building. The seal 272 is made from an elastomer material so as to conform closely to the flange 248, the can opening 234, and the panel 224. The seal 272 is adapted to minimize airflow through the interface between the shell 238 and the can 226, and between the can 226 and the panel 224.

An optional ocular plate 274 is mounted on the shell 238 adjacent the lower end 242, so as to condition light and pass light outward. The ocular plate 274 can be a diffuser, a filter, a fresnel lens, or any element that will pass light outward, and process the light as desired. Mounting can be effected by snapping the ocular plate 274 into the shell 238 by means well known in the art.

Numerous modifications and alternative embodiments of the invention will be apparent to those skilled in the art in view of the foregoing description. Accordingly, this description is to be construed as illustrative only and is for the purpose of teaching those skilled in the art the best mode of carrying out the invention. Details of the structure may be varied substantially without departing from the spirit of the invention and the exclusive use of all modifications that will come within the scope of the appended claims is reserved.

### PARTS LIST

### LINER FOR A RECESSED LIGHT HOUSING

Part No. Description
22 recessed light housing
24 panel
26 can
28 can aperture
30 source of electrical current
32 junction box
34 can opening
36 liner
38 shell
40 sidewall
42 lower end
44 upperend
46 roof
48 flange
50 first electrical light socket
52 wire nuts
54 grommet
56 grommet ratchet
58 cable tie tape
60 tape first end
62 tape second end
64 tape gear rack
66 mounting pad
68 mounting pad hole
70 threaded fastener
72 seal
74 ocular plate
122 recessed light housing
124 panel
126 can
128 can aperture
130 source of electrical current
132 junction box
134 can opening
136 liner
138 shell
139 mounting boss
140 sidewall
142 lower end
144 upper end
146 roof
148 flange
150 first electrical light socket
151 mounting plate
152 wire nut
154 grommet
156 grommet ratchet
158 cable tie tape
160 tape first end
162 tape second end
164 tape gear rack
166 mounting pad
168 mounting pad hole
170 threaded fastener
172 seal
174 ocular plate
176 connection chamber
222 recessed light housing
224 panel 290 mounting hole
226 can
228 can aperture
230 source of electrical current
232 junction box
234 can opening
236 liner
238 shell
240 sidewall
242 lower end
244 upper end
246 roof
248 flange
250 first electrical light socket
252 wire nut
254 grommet
256 grommet ratchet
258 cable tie tape
260 tape first end
262 tape second end
264 tape gear rack
266 mounting pad
268 mounting pad hole
270 threaded fastener
272 seal
274 ocular plate
276 second electrical light socket
278 plug
280 electrical cord
282 bolt
284 bolt upper end
286 bolt lower end
288 nut
290 mounting hole

1. A liner for use in connection with a recessed light housing mounted in a panel, the recessed light housing having a can with apertures therethrough and a source of electrical current, the can having an opening adjacent the panel, the liner comprising:
a shell, the shell having a generally circular sidewall extending from a lower end adjacent the can opening to an upper end, the shell having a roof at the upper end, the shell having a flange at the lower end, the flange being adapted to overlap the can opening, the shell being adapted to fit into the can;
a first electrical light socket mounted in the shell, the first electrical light socket being adapted for connection to the source of electrical current; and
mounting means for mounting the shell in the can.

2. The liner of claim 1, further comprising a seal interposed between the flange and the can opening, so as to limit air leakage past the liner.

3. The liner of claim 1, further comprising an ocular plate mounted on the shell adjacent the lower end, so as to condition light and pass light outward.

4. The liner of claim 1, wherein the mounting means further comprises:
at least one cable tie grommet, the grommet having an integrated ratchet, the grommet being mounted in the shell roof,
at least one cable tie tape extending between opposite first and second ends, the tape having an integrated gear rack, the tape being adapted to pass through the grommet, the gear rack being adapted to mesh with the ratchet so as to allow the tape to pass through the grommet in one direction, but not in the opposite direction, the tape having a mounting pad on the first end, the mounting pad being adapted for mounting the tape on the can, the tape and grommet being molded from a polymeric material; and
securing means for securing the mounting pad onto the can.

5. The liner of claim 4, wherein the securing means further comprises a threaded fastener.

6. The liner of claim 4, wherein the securing means further comprises a blind rivet.

7. The liner of claim 4, wherein the securing means further comprises an adhesive.

8. The liner of claim 1, wherein the mounting means further comprises:
the shell having at least one mounting hole through the shell;
at least one bolt extending between opposite upper and lower ends, the upper end being hook-shaped and adapted to engage one of the apertures through the can, the lower end being threaded and adapted to pass through the mounting hole; and
at least one nut adapted to engage the bolt threaded lower end, thereby securing the shell in the can.

9. The liner of claim 1, further comprising:
a second electrical light socket mounted inside the can, the source of electrical current being connected to the second electrical light socket;
a plug adapted to screw into the second electrical light socket, making an electrical connection with the second electrical light socket; and
an electrical cord electrically connecting the plug with the first electrical light socket.

10. The liner of claim 1, further comprising:
the shell having at least one mounting boss spaced below the roof;
a mounting plate attached to the mounting boss;
the first electrical light socket being mounted in the mounting plate; and
a connection chamber enclosed by the mounting plate, the roof, and the sidewall, for making the connection between the first electrical light socket and the source of electrical current.

11. A liner for use in connection with a recessed light housing mounted in a panel, the recessed light housing having a can with apertures therethrough and a source of electrical current, the can having an opening adjacent the panel, the liner comprising:
a shell, the shell having a generally circular sidewall extending from a lower end adjacent the can opening to an upper end, the shell having a roof at the upper end, the shell having a flange at the lower end, the flange being adapted to overlap the can opening, the shell being adapted to fit into the can;
a first electrical light socket mounted in the shell, the first electrical light socket being adapted for connection to the source of electrical current;
at least one cable tie grommet, the grommet having an integrated ratchet, the grommet being mounted in the shell roof,
at least one cable tie tape extending between opposite first and second ends, the tape having an integrated gear rack, the tape being adapted to pass through the grommet, the gear rack being adapted to mesh with the ratchet so as to allow the tape to pass through the grommet in one direction, but not in the opposite direction, the tape having a mounting pad on the first end, the mounting pad being adapted for mounting the tape on the can, the tape and grommet being molded from a polymeric material; and
securing means for securing the mounting pad onto the can.

12. The liner of claim 11, further comprising a seal interposed between the flange and the can opening, so as to limit air leakage past the liner.

13. The liner of claim 11, further comprising an ocular plate mounted on the shell adjacent the lower end, so as to condition light and pass light outward.

14. The liner of claim 11, wherein the securing means further comprises a threaded fastener.

15. The liner of claim 11, wherein the securing means further comprises a blind rivet.

16. The liner of claim 11, wherein the securing means further comprises an adhesive.

17. The liner of claim 11, further comprising:
a second electrical light socket mounted inside the can, the source of electrical current being connected to the second electrical light socket;
a plug adapted to screw into the second electrical light socket, making an electrical connection with the second electrical light socket; and
an electrical cord electrically connecting the plug with the first electrical light socket.

18. The liner of claim 11, further comprising:
the shell having at least one mounting boss spaced below the roof;
a mounting plate attached to the mounting boss;
the first electrical light socket being mounted in the mounting plate; and
a connection chamber enclosed by the mounting plate, the roof, and the sidewall, for making the connection between the first electrical light socket and the source of electrical current.

19. A liner for use in connection with a recessed light housing mounted in a panel, the recessed light housing having a can with apertures therethrough and a source of electrical current, the can having an opening adjacent the panel, the liner comprising:
a shell, the shell having a generally circular sidewall extending from a lower end adjacent the can opening to an upper end, the shell having a roof at the upper end, the shell having a flange at the lower end, the flange being adapted to overlap the can opening, the shell being adapted to fit into the can;
a first electrical light socket mounted in the shell root the first electrical light socket being adapted for connection to the source of electrical current;
a pair of cable tie grommets, each grommet having an integrated ratchet, the pair of grommets being mounted in the shell roof and spaced apart;
a pair of cable tie tapes, each tape extending between opposite first and second ends, each tape having an integrated gear rack, each tape being adapted to pass through one of the grommets, each gear rack being adapted to mesh with one of the ratchets so as to allow each tape to pass through the respective grommet in one direction, but not in the opposite direction, each tape having a mounting pad on the first end with a hole through the pad, the mounting pad being adapted for mounting the tape on the can, each tape and grommet being molded from a polymeric material;
a threaded fastener for securing the mounting pad onto the can; and
a seal interposed between the flange and the can opening, so as to limit air leakage past the liner.

20. The liner of claim 19, further comprising an ocular plate mounted on the shell adjacent the lower end, so as to condition light and pass light outward.
